(19) United States
(12) Patent Application Publication
(10) Pub. No.: US 2026/0261379 A1
(43) Pub. Date: Sep. 3, 2026

(54) ANTENNA PORT TABLES FOR PHYSICAL DOWNLINK SHARED CHANNEL WITH INCREASED NUMBER OF FREQUENCY DIVISION CODES

(71) Applicant: Telefonaktiebolaget LM Ericsson (PUBL), Stockholm (SE)

(72) Inventors: Andreas NILSSON, Göteborg (SE); Shiwei GAO, Nepean (CA); Siva MURUGANATHAN, Stittsville (CA); Sven JACOBSSON, Västra Frölunda (SE); Jianwei ZHANG, Solna (SE); Mattias FRENNE, Uppsala (SE)

(21) Appl. No.: 18/846,727

(22) PCT Filed: Mar. 13, 2023
(86) PCT No.: PCT/EP2023/056330

§ 371 Date: Sep. 13, 2024

Related U.S. Application Data
(60) Provisional application No. 63/319,339, filed on Mar. 13, 2022.

(51) Int. Cl. H04L 5/00

(52) U.S. Cl. CPC H04L 5/0051; H04L 5/0016

(57) ABSTRACT

A method (700) by a user equipment, UE (112), for receiving a physical downlink shared channel, PDSCH, transmission includes receiving (702), from a network node (110), in a Downlink Control Information, DCI, information about two or more Demodulation Reference Signal, DMRS, ports in a Code Division Multiplexing, CDM, group associated to the PDSCH transmission. The two or more DMRS ports are orthogonal at length n, and the two or more DMRS ports are orthogonal over a partial length n′ that is less than n. The UE receives (704), from the network node, the PDSCH transmission with the two or more DMRS ports in the CDM group.

### TECHNICAL FIELD

The present disclosure relates, in general, to wireless communications and, more particularly, systems and methods including antenna port tables for Physical Downlink Shared Channel (PDSCH) with increased number of frequency division codes.

### BACKGROUND

New Radio (NR) uses Cyclic Prefix-Orthogonal Frequency Division Multiplexing (CP-OFDM) in both downlink (i.e., from a network node, gNodeB (gNB), or base station to a user equipment (UE)) and uplink (i.e., from a UE to a, network node, gNB, or base station). Discrete Fourier Transform (DFT) spread Orthogonal Frequency Division Multiplexing (OFDM) is also supported in the uplink. In the time domain for NR, downlink (DL) and uplink (UL) are organized into equally-sized subframes of Ims each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically on a slot basis. FIG. 1 illustrates an example of a NR time-domain structure with a 14-symbol slot and 15 kHz subcarrier spacing. Specifically, FIG. 1 shows the first two symbols containing physical downlink control channel (PDCCH) and the rest contains physical shared data channel, which may be either PDSCH or Physical Uplink Shared Channel (PUSCH).

Different subcarrier spacing values are supported in NR. The supported subcarrier spacing values (also referred to as different numerologies) are given by Δf=(15×2^{μ}) kHz where μ∈0, 1, 2, 3, 4. Δf=15 kHz is the basic subcarrier spacing. The slot durations at different subcarrier spacings is given by

$$\frac{1}{{2}^{μ}} ms .$$

In the frequency domain (FD), a system bandwidth is divided into resource blocks (RBs), and each RB corresponds to 12 contiguous subcarriers. The RBs are numbered starting with 0 from one end of the system bandwidth. FIG. 2 illustrates the basic NR physical time-frequency resource grid where only one RB within a 14-symbol slot is shown. One OFDM subcarrier during one OFDM symbol interval forms one resource element (RE).

PDSCH transmissions on the DL can be either dynamically scheduled (i.e., in each slot, the gNB transmits downlink control information (DCI) over PDCCH about which UE data is to be transmitted to and which RBs in the current downlink slot the data is transmitted on) or semi-persistently scheduled (SPS) in which periodic PDSCH transmissions are activated or deactivated by a DCI. Different DCI formats are defined in NR for DL PDSCH scheduling, including DCI format 1_0, DCI format 1_1, and DCI format 1_2.

Similarly, PUSCH transmissions on the UL can also be scheduled either dynamically or semi-persistently with UL grants carried in PDCCH. NR supports two types of semi-persistent UL transmission. Type 1 configured grant (CG) is configured and activated by Radio Resource Control (RRC) while type 2 CG is configured by RRC but activated/deactivated by DCI. The DCI formats for scheduling PUSCH include DCI format 0_0, DCI format 0_1, and DCI format 0_2.

### Demodulation Reference Signals (DMRS) Configuration

DMRS are used for coherent demodulation of physical layer data channels (i.e., PDSCH and PUSCH), as well as of PDCCH. The DMRS is confined to resource blocks carrying the associated physical layer channel and is mapped on allocated resource elements (REs) of the time-frequency resource grid such that the receiver can efficiently handle time/frequency-selective fading radio channels.

The mapping of DMRS to REs is configurable in both the FD and time domain. There are two mapping types in the FD, i.e., type 1 and type 2. In addition, there are two mapping types in the time domain, i.e., mapping type A and type B, which define the symbol position of the first OFDM symbol containing DMRS within a transmission interval.

The DMRS mapping in time domain can further be single-symbol based or double-symbol based, where the latter means that DMRS is mapped in pairs of two adjacent OFDM symbols. For single symbol based DMRS, a UE can be configured with one, two, three, or four single-symbol DMRS in a slot. For double-symbol based DMRS, a UE can be configured with one or two double-symbol DMRS in a slot. In scenarios with low Doppler, it may be sufficient to configure front-loaded DMRS only, which may include one single-symbol DMRS or one double-symbol DMRS. However, in scenarios with high Doppler, additional DMRS may be required in a slot.

FIG. 3 illustrates an example of type 1 and type 2 front-loaded DMRS with single-symbol and double-symbol DMRS and time domain mapping type A with first DMRS in the third OFDM symbol of a transmission interval of 14 symbols. It may be observed from FIG. 3 that type 1 and type 2 differs with respect to both the mapping structure and the number of supported DMRS Code Division Multiplexing (CDM) groups where type 1 support 2 CDM groups and Type 2 support 3 CDM groups.

A DMRS antenna port is mapped to the REs within one CDM group only. For single-symbol DMRS, two antenna ports can be mapped to each CDM group whereas for double-symbol DMRS four antenna ports can be mapped to each CDM group. Hence, for DMRS type 1, the maximum number of DMRS ports is four for a single-symbol based DMRS configuration and eight for double-symbol based DMRS configuration. For DMRS type 2, the maximum number of DMRS ports is six for a single-symbol based DMRS configuration and twelve for double-symbol based DMRS configuration.

An orthogonal cover code (OCC) of length 2 (i.e., [+1, +1] or [+1, −1]) is used to separate antenna ports mapped in the same two REs within a CDM group. The OCC is applied in FD as well as in time domain when double-symbol DMRS is configured. This is illustrated in FIG. 3 for CDM group 0.

In NR Rel-15, the mapping of a PDSCH DMRS sequence r (m), m=0, 1, . . . on antenna port p and subcarrier k in OFDM symbol l for the numerology index u is specified in 3GPP TS 38.211 as

$${a}_{k , l}^{( p , μ )} = {β}_{P D S C H}^{D M R S} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

where w_{f}(k′) represents a FD length 2 OCC code and wₜ(l′) represents a time domain length 2 OCC code. Table 1 and Table 2 show the PDSCH DMRS mapping parameters for configuration type 1 and type 2, respectively.

TABLE 1
PDSCH DMRS mapping parameters for
configuration type 1.

| | CDM | | w_{f} (k′) | | wₜ (l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DMRS mapping parameters for
configuration type 2.

| | CDM | | w_{f} (k′) | | wₜ (l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

For PDSCH mapping type A, DMRS mapping is relative to slot boundary. That is, the first front-loaded DMRS symbol in DMRS mapping type A is in either the 3rd or 4th symbol of the slot. In addition to the front-loaded DMRS, type A DMRS mapping can consist of up to 3 additional DMRS. FIG. 4 illustrates some examples of DMRS for mapping type A. It may be noted that PDSCH length of 14 symbols is assumed in the examples illustrated in FIG. 4. Additionally, FIG. 4 assumes that the PDSCH duration is the full slot. If the scheduled PDSCH duration is shorter than the full slot, the positions of the DMRS changes according to the specification 3GPP TS 38.211.

For PDSCH mapping type B, DMRS mapping is relative to transmission start. That is, the first DMRS symbol in DMRS mapping type B is in the first symbol in which type B PDSCH starts. FIG. 5 illustrates some examples of DMRS for mapping type B.

The same DMRS design for PDSCH is also applicable for PUSCH when transform precoding is not enabled, where the sequence r(m) shall be mapped to the intermediate quantity

$${\tilde{a}}_{k , l}^{( {\tilde{p}}_{j} , μ )}$$

for DMRS port \tilde{p}ⱼ according to

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , υ - 1$$

where w_{f}(k′), wₜ(l′), and A are given by Tables 6.4.1.1.3-1 and 6.4.1.1.3-2 in 3GPP TS 38.211, which are reproduced below in Tables 3 and 4, respectively, and v is the number of PUSCH transmission layers. The intermediate quantity

$${\tilde{a}}_{k , l}^{( {\tilde{p}}_{j} , μ )} = 0$$

if Δ corresponds to any other antenna ports than \tilde{p}ⱼ.

The intermediate quantity

$${\tilde{a}}_{k , l}^{( {\tilde{p}}_{j} , μ )}$$

shall be precoded, multiplied with the amplitude scaling factor

$${β}_{PUSCH}^{D M R S}$$

in order to conform to the transmit power specified in clause 6.2.2 of 3GPP TS 38.214, and mapped to physical resources according to:

$$[ \begin{matrix}{a}_{k , l}^{{p}_{0} , μ} \\ ⋮ \\ {a}_{k , l}^{( {p}_{ρ - 1} , μ )}\end{matrix} ] = {β}_{PUSCH}^{D M R S} W [ \begin{matrix}{\tilde{a}}_{k , l}^{( {\tilde{p}}_{0} , μ )} \\ ⋮ \\ {\tilde{a}}_{k , l}^{( {\tilde{p}}_{υ - 1} , μ )}\end{matrix} ]$$

where
the precoding matrix W is given by clause 6.3.1.5 of 3GPP TS 38.211,
{p₀, . . . , p_{ρ-1}} is a set of physical antenna ports used for transmitting the PUSCH, and
{\tilde{p}₀, . . . , \tilde{p}_{υ-1}} is a set of DMRS ports for the PUSCH;

TABLE 3
Parameters for PUSCH DMRS
configuration type 1.

| | CDM | | w_{f} (k′) | | wₜ (l′) | |
|---|---|---|---|---|---|---|
| \tilde{p} | group λ | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 4
Parameters for PUSCH DMRS
configuration type 2.

| | CDM | | w_{f} (k′) | | wₜ (l′) | |
|---|---|---|---|---|---|---|
| \tilde{p} | group λ | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

The DMRS sequence r(n) for both PDSCH and PUSCH is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) )$$

where the pseudo-random sequence c(i) is defined in clause 5.2.1 of 3GPP TS 38.211. The pseudo-random sequence generator is initialized with:

$${c}_{i n i t} = ( {2}^{17} ( {N}_{s y m b}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot,

$${n}_{s , f}^{μ}$$

is the slot number within a frame, and
For PDSCH DMRS,

$${N}_{I D}^{0} , {N}_{I D}^{1} ∈ \{ 0 , 1 , … , 65535 \}$$

are given by the higher-layer parameters scramblingID0 and scramblingID1, respectively, in the DMRS-DownlinkConfig Information Element (IE) if provided and the PDSCH is scheduled by PDCCH using DCI format 1_1 or 1_2 with the CRC scrambled by Cell-Radio Network Temporary Identifier (C-RNTI), Modulation Coding Scheme C-RNTI (MCS-C-RNTI), or CS-RNTI;
For PUSCH DMRS,

$${N}_{I D}^{0} , {N}_{I D}^{1} ∈ \{ 0 , 1 , … , 65535 \}$$

are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a CG;
For PDSCH DMRS,

$${N}_{I D}^{0} ∈ \{ 0 , 1 , … , 65535 \}$$

iS given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI;
For PUSCH DMRS,

$${N}_{I D}^{0} ∈ \{ 0 , 1 , … , 65535 \}$$

is given by the higher-layer parameter scramblingID0 in the DMRS-UplinkConfig IE if provided and the PUSCH is scheduled by DCI format 0_1 or 0_2, or by a PUSCH transmission with a CG;

$${N}_{I D}^{{\overline{n}}_{S C I D}^{λ}} = {N}_{I D}^{cell}$$

otherwise;

$${\overline{n}}_{S C I D}^{\overline{λ}}$$

and λ̅ are given by
   if the higher-layer parameter dmrs-Downlink in the DMRS-DownlinkConfig IE or dmrs-Uplink in the DMRS-UplinkConfig IE is provided, the corresponding

$${\overline{n}}_{S C I D}^{\overline{λ}}$$

and λ̅ are determined as

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where λ is the CDM group index.
otherwise by

$${\overline{n}}_{S C I D}^{\overline{λ}} = {n}_{S C I D}$$

$$\overline{λ} = 0$$

The quantity n_{SCID}∈{0, 1} is given by the DMRS sequence initialization field, if present, in the DCI associated with the PDSCH transmission if DCI format 1_1 or 1_2 is used or the PUSCH transmission if DCI format 0_1 or 0_2 is used, or indicated by the higher layer parameter dmrs-SeqInitialization, if present, for a Type 1 PUSCH transmission with a CG; otherwise n_{SCID}=0.

### DMRS Ports Signaling

DMRS port(s) for a PDSCH or a PUSCH are signaled in the corresponding scheduling DCI. In addition to the DMRS ports, the number of CDM groups that are not allocated for PDSCH or PUSCH are signaled. Also, the number of front-loaded DMRS symbols are dynamically signaled in the DCI.

In PUSCH scheduling, the number of layers are indicated separately from DMRS ports signaling in the DCI. While for PDSCH scheduling, the number of layers and DMRS ports are signaled jointly in the DCI.

An “antenna port(s)” bit field in DCI is used the purpose. An example for type 1 DMRS with rank=1 and up to two maximum number of front-loaded DMRS OFDM symbols for PUSCH is shown in Table 5, which corresponds to Table 7.3.1.1.2-12 of 3GPP TS 38.212. Similarly, Table 6 corresponds to Table 7.3.1.1.2-13 of 3GPP TS 38.212. Here, 4 bits are used. It may be noted that DMRS type and maximum number of front-loaded DMRS symbols are semi-statically configured by RRC.

TABLE 5

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Antenna port(s), transform precoder is disabled, dmrs-Type = 1, maxLength = 2, rank = 1 (from 3GPP TS 38.212)

TABLE 6

| | Number of DMRS CDM | DMRS | Number of |
|---|---|---|---|
| Value | group(s) without data | port(s) | front-load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Antenna port(s), transform precoder is disabled, dmrs-Type = 1, maxLength = 2, rank = 2

Another example for type 1 DMRS with up to two maximum number of front-loaded DMRS OFDM symbols for PDSCH is shown in Table 7, which corresponds to Table 7.3.1.2.2-2 of 3GPP TS 38.212.

TABLE 7
Antenna port(s) (1000 + DMRS port), dmrs-Type = 1, maxLength = 2 (from TS38.212 of 3GPP)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

There currently exist certain challenge(s), however. For example, in existing NR, up to 4 and 6 DMRS ports can be supported with single-symbol based type 1 and type 2 DMRS configurations, respectively, and up to 8 and 12 orthogonal DMRS ports can be supported with double-symbol based type 1 and type 2 DMRS configurations, respectively. With centralized scheduling of UEs covered by multiple Transmission Reception Points (TRPs), the existing maximum number of DMRS ports can be a limitation because more UEs may be scheduled simultaneously in the same time-frequency resource in UL or DL over multiple TRPs. How to further increase the number of DMRS ports in the same DMRS resources without additional overhead is an objective to be studied in NR Rel-18.

For DMRS configuration with DMRS-Type1 and maxLength=1, the number of co-scheduled UEs for Multiple User-Multiple Input Multiple Output (MU-MIMO) is very limited if the network wants to keep DMRS sequence for co-scheduled UEs being orthogonal. Only one rank 4 UE can be scheduling at a time, and if there's a rank 3 transmission, one rank 1 transmission can be scheduled together on overlapping frequency resources. One motivation for increasing the number of orthogonal ports is to increase the number of co-scheduled MU-MIMO UE with higher rank.

### SUMMARY

Certain aspects of the disclosure and their embodiments may provide solutions to these or other challenges. For example, methods and systems are provided for signalling, from the network to the UE, the applied DMRS ports for a scheduled PDSCH reception when the UE is configured with an extended number of orthogonal DMRS ports such as that specified in Rel-18, and where the extended number of orthogonal DMRS ports are designed by increasing the number of FD-OCC code.

According to certain embodiments, a method by a UE for receiving a PDSCH transmission includes receiving, from a network node, in a DCI, information about two or more DMRS ports in a CDM, group associated to the PDSCH transmission. The two or more DMRS ports are orthogonal at a length n, and the two or more DMRS ports are orthogonal over a partial length n′ that is less than n. The UE receives, from the network node, the PDSCH transmission with the two or more DMRS ports in the CDM group.

According to certain embodiments, a UE for receiving a PDSCH transmission is adapted to receive, from a network node, in a DCI, information about two or more DMRS ports in a CDM, group associated to the PDSCH transmission. The two or more DMRS ports are orthogonal at a length n, and the two or more DMRS ports are orthogonal over a partial length n′ that is less than n. The UE is adapted to receive, from the network node, the PDSCH transmission with the two or more DMRS ports in the CDM group.

According to certain embodiments, a method by a network node for transmitting a PDSCH transmission includes transmitting, to a UE, in a DCI, information about two or more DMRS ports in a CDM, group associated to the PDSCH transmission. The two or more DMRS ports are orthogonal at a length n, and the two or more DMRS ports are orthogonal over a partial length n′ that is less than n. The network node transmits, to the UE, the PDSCH transmission with the two DMRS ports in the CDM group.

According to certain embodiments, a network node for transmitting a PDSCH transmission is adapted to transmit, to a UE, in a DCI, information about two or more DMRS ports in a CDM, group associated to the PDSCH transmission. The two or more DMRS ports are orthogonal at a length n, and the two or more DMRS ports are orthogonal over a partial length n′ that is less than n. The network node is adapted to transmit, to the UE, the PDSCH transmission with the two DMRS ports in the CDM group.

Certain embodiments may provide one or more of the following technical advantage(s). For example, certain embodiments may provide a technical advantage of introducing antenna port indication tables designed with good robustness against delay spread and with good orthogonality towards legacy DMRS ports, which in turn will increase the capacity for UL MU-MIMO since more UEs can be served simultaneously while still maintaining a decent DMRS channel estimation quality.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a NR time-domain structure with a 14-symbol slot and 15 kHz subcarrier spacing;

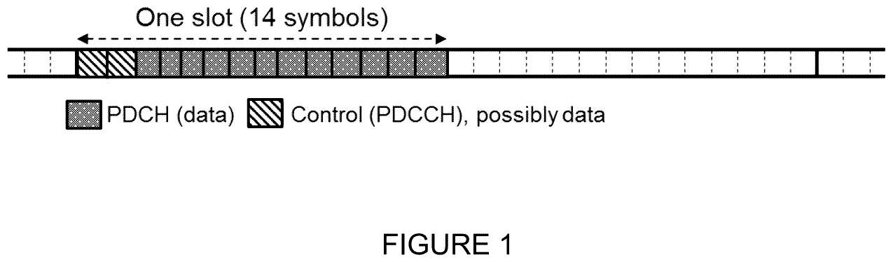

FIG. 2 illustrates the basic NR physical time-frequency resource grid;

FIG. 3 illustrates an example of type 1 and type 2 front-loaded DMRS with single-symbol and double-symbol DMRS and time domain mapping type A with first DMRS in the third OFDM symbol of a transmission interval of 14 symbols;

FIG. 4 illustrates some examples of DMRS for mapping type A;

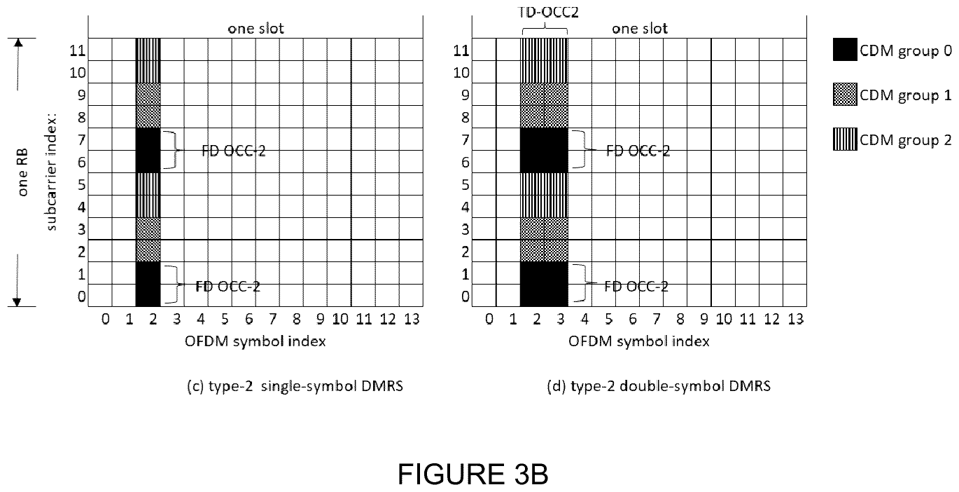

FIG. 5 illustrates some examples of DMRS for mapping type B;

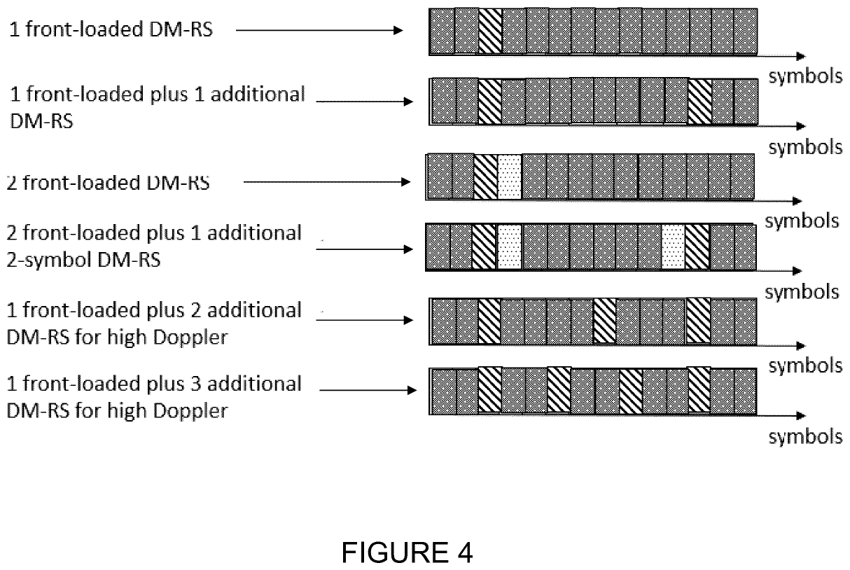

FIG. 6 illustrates an example DMRS port numbering for DMRS type 1, according to certain embodiments;

FIG. 7 illustrates an example of DMRS port numbering for DMRS type 2, according to certain embodiments;

FIG. 8 illustrates an example communication system, according to certain embodiments;

FIG. 9 illustrates an example UE, according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates a method by a UE for receiving a PDSCH transmission, according to certain embodiments; and

FIG. 15 illustrates a method by a network node for providing information for a PDSCH transmission, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

According to certain embodiments described herein, it is assumed that the UE is implemented with a Rel-18 DMRS port extension framework for Type 1 DMRS and/or Type 2 DMRS, and where the number of CDM groups remains the same as in NR Rel-15 (i.e., 2 CDM groups for Type 1 DMRS and 3 CDM groups for type 2 DRMS), and where increased number of orthogonal frequency codes are used per CDM group to extend the number of DMRS ports. For example, as just one example, the FD-OCC code length could be increased from 2 to 4 per CDM group. It is recognized, however, that other frequency coding techniques can be used. For example, cyclic shifts can be introduced with different sequence lengths.

According to certain embodiments, it is assumed that there is a set A of DMRS ports that is defined for legacy terminals such as, for example legacy UEs, and an extended set B of DMRS ports that is defined only for new terminals of an NR Release such as NR Release 18 or beyond. Hence, the available DMRS ports for new terminals are both the legacy set A of ports and a new set B of DMRS ports.

According to certain particular embodiments, a terminal is configured to use the new ports in set B (or the new ports plus the legacy ports concurrently, i.e. set A and B). If not configured, the new terminal should, in particular embodiments, only assume the legacy ports in set A are used. This is useful in case the network doesn't support the new ports although the UE support the new ports. Herein, the term legacy DMRS ports refer to DMRS ports supported in NR up until NR Rel-17 and is given by the following:
for single symbol PUSCH (or PDSCH) DMRS of type 1 (dmrs-Type=1 and maxLength=1), the legacy ports are given by ports 12 with values 0-3 as defined in Table 3 above;
for two or double symbol PUSCH (or PDSCH) DMRS of type 1 (dmrs-Type=1 and maxLength=2), the legacy ports are given by ports \tilde{p} with values 0-3 as defined in Table 3 above;
for single symbol PUSCH (or PDSCH) DMRS of type 2 (dmrs-Type=2 and maxLength=1), the legacy ports are given by ports P with values 0-5 as defined in Table 4 above; and
for two or double symbol PUSCH (or PDSCH) DMRS of type 2 (dmrs-Type=2 and maxLength=2), the legacy ports are given by ports P with values 6-11 as defined in Table 4 above.

For example, according to certain embodiments, a method by a UE for receiving a PDSCH transmission includes obtaining an allocation of a number of DMRS ports per CDM group per resource block, where the DMRS ports per CDM group per resource block are differentiated by different FD codes. The UE receives an indication of a codepoint of an antenna port field in a DCI for scheduling the reception of the PDSCH transmission. Based on the indication of the codepoint of the antenna port field and the allocation of the number of DMRS ports per CDM group per resource block, the UE determines at least one DMRS port for receiving the PDSCH transmission. Each DMRS port corresponds to one FD code of length, n, and one CDM group, and if there are two or more DMRS ports, the two or more DMRS ports are orthogonal at a length n, and corresponding subsets within each FD code with length n′ that is less than n are orthogonal at length n′. The UE receives the PDSCH transmission according to the determined at least one DMRS port.

According to certain embodiments, a method by a network node for providing information for a PDSCH transmission includes obtaining an allocation of a number of DMRS ports per CDM group per resource block, where the DMRS ports per CDM group per resource block are differentiated by different FD codes. The network node transmits, to the UE, an indication of a codepoint of an antenna port field in a DCI for scheduling the PDSCH transmission. Based on the indication of the codepoint of the antenna port field and the allocation of the number of DMRS ports per CDM group per resource block, the network node determines at least one DMRS port for the PDSCH transmission, wherein each DMRS port corresponds to one FD code of length, n, and one CDM group, and wherein if there are two or more DMRS ports, the two or more DMRS ports are orthogonal at length n, and wherein corresponding subsets within each FD code with length n′ that is less than n are orthogonal at length n′. The network node transmits, to the UE, the PDSCH transmission according to the determined at least one DMRS port.

According to certain embodiments, a terminal may also indicate to the network whether it supports the new ports of set B, via UE capability signaling. If this is not indicated, the network can assume that the new terminal does not support the feature of new DMRS ports of set B. It should be noted here that not all new terminals may support the feature of new DMRS ports of set B and, thus, such UE capability signaling is beneficial to let the network know on whether or not the new DMRS ports of set B are supported by the UE.

In a particular embodiment, for example, the new antenna port tables disclosed herein should be used when the UE is RRC configured with the new extended DMRS design, which for example can be RRC configured by introducing a new parameter or flag in DMRS-Uplink as specified in 3GPP TS 38.331. An example of RRC configuration for the new DMRS is shown below:

DMRS-UplinkConfig information element

```
-- ASN1START
-- TAG-DMRS-ULPINKCONFIG-START
DMRS-UplinkConfig ::= SEQUENCE {
    ...,
  [[
  dmrs-Uplink-r18 ENUMERATED {enabled} OPTIONAL -- Need R
  ]]
}
-- TAG-DMRS-UPLINKCONFIG-STOP
-- ASN1STOP
```

With the increased number of DMRS ports, more bits are needed to signal the set of DMRS ports for PDSCH. To reuse implementation for existing type-1 or type-2 DMRS port signalling, in a particular embodiment, new antenna port tables can be constructed by adding new rows to the existing antenna port tables so that there is no change of the existing codepoints in the antenna port field in DCI. In a particular embodiment, since the new antenna port tables have more entries for the new extended DMRS design, an additional bit is added to the DCI bitfield called “Antenna ports” of DCI Format 0_1 and DCI Format 0_2 when and only when the UE is RRC configured with the new extended DMRS design.

First, the following definition is made:
Definition: If two orthogonal vectors

$${v}_{1} = [ \begin{matrix}{v}_{1 , 1} \\ … \\ {v}_{1 , K}\end{matrix} ] and {v}_{2} = [ \begin{matrix}{v}_{2 , 1} \\ … \\ {v}_{2 , K}\end{matrix} ] ( {v}_{1}^{H} {v}_{2} = 0 )$$

of sequence length N are orthogonal over every K sequence parts of length N′<N (where N=N′*K), i.e.,

$${v}_{1 , i}^{H} {v}_{2 , i} = 0 ,$$

i=1, . . . , K, the vectors v₁ and v₂ are said to be super-orthogonal.

It is assumed that the design of set B of DMRS ports has some further properties:
All ports in set B that maps to the same set of N_{B} resource elements (e.g. a comb of subcarriers also referred to a CDM group) are mutually orthogonal over the set of Ng resource elements, where typically N_{B}=4. Two DMRS ports are said to be orthogonal if the corresponding sequences are orthogonal over the N_{B} resource elements.
The ports in set B can be further divided into two subsets B1 and B2
   At least ports in subset B1 are mutually orthogonal across N_{B1}<N_{B} resource elements, typically N_{B1=2}. This property is thus super-orthogonality (see example below).

For example, the vectors of orthogonal cover codes [1 1 1 1] and [1 −1 1 −1] of length four are super-orthogonal as they are also orthogonal over the partial length two ([1 1] and [1−1]). These length four vectors could therefore belong to the subset B1 while the vectors [1 j −1−j] and [1−j −1 j] belong to subset B2 (which by the way also are super-orthogonal). The union of B1 and B2 form a set B of orthogonal vectors which are not all mutually super-orthogonal. Note that a vector from B2 and a vector from B1 are not mutually super-orthogonal.

The property of super-orthogonality between some DMRS ports (i.e. subset B1) and the relation to other DMRS ports (i.e. sets B and A) is utilized herein.

It is observed that for a receiver to perform channel estimation using multiple DMRS ports (for example a rank 2 reception of 2 ports), it can be beneficial if super-orthogonal DMRS ports are used for the two layers compared to if “only” orthogonal ports are used. This benefit can be explained if time domain channel estimation algorithms are used, where a domain transform (such as a DFT) is used on the received DMRS. Two super-orthogonal ports have a larger sample (i.e., time) separation after the transform compared to two non-super orthogonal ports and this is important property if there is a delay in channel that introduce cross interference between two DMRS ports. To maximize the robustness against channel delays, super-orthogonal DMRS ports should be used, or equivalently, the cyclic shifts of the DMRS port sequences in time domain should be maximized.

Alternatively, if FD channel estimation algorithms are used, the shorter sequence length n′ to obtain orthogonality between super-orthogonal ports implies that the channel estimator can operate on n′ samples at a time instead of n>n′ samples, which makes the system less vulnerable to delays spread/frequency selectivity. The improved channel estimation performance will improve the user throughput, especially for higher order modulation and higher code rates.

According to certain embodiments, there exist orthogonal and super-orthogonal ports within the new set B is utilized to define the antenna port indication tables as to assign ports to a data transmission so that the channel estimation performance is maximized.

In a particular embodiment, super-orthogonal ports B1 or B2 should primarily be used, if possible, and if more ports are needed, then ports from the full (orthogonal) set of ports is used.

The following principles form the basis for the creating of antenna port indication tables for UL transmission (PDSCH DMRS ports):
DMRS ports assigned to a UE are using super-orthogonal ports when possible;
DMRS ports assigned to UEs are orthogonal to legacy DMRS ports, such that legacy UEs and Rel-18 UEs can be co-scheduled for UL MU-MIMO.

### Port Numbering for DMRS Type 1

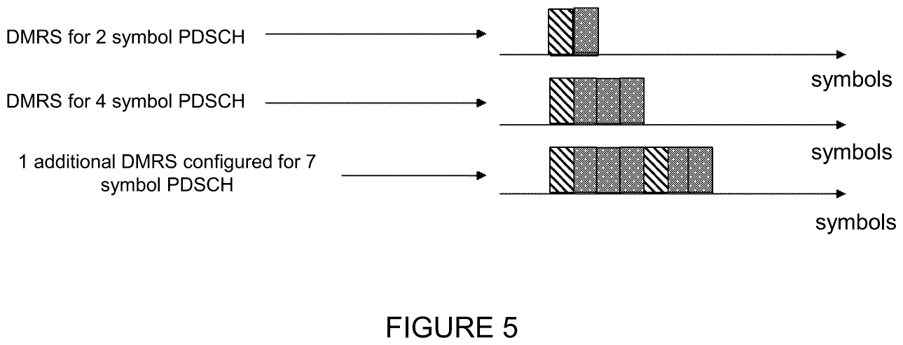

FIG. 6 illustrates an example 50 of DMRS port numbering for DMRS type 1, according to certain embodiments. More specifically, according to certain embodiments, FIG. 6 illustrates an example DMRS port number definition for Type 1 DMRS for the Rel-18 UEs (set B DMRS ports) where the ports within B1 are mutually super-orthogonal with each other and the ports within B2 are mutually super-orthogonal with each other. For legacy UEs (set A), it is assumed that the same DMRS port numbering and definitions are used as those described in NR Rel-15 specification. Please note that, herein, a FD-OCC code of length 4 has been assumed for the set B DMRS ports; however, that is just one example of how these new DMRS Ports can be implemented by extending the number of orthogonal FD codes per CDM group. By this assumed definition, it can be seen that DMRS port 0 & 1 of set B are the same as the DMRS port 0 & 1 of the legacy DMRS ports (i.e., from set A), assuming the same DMRS sequences are re-used for DMRS Rel-18 as was used for DMRS Rel-15/16. It can also be seen that DMRS port 4 & 5 of set B are the same as the DMRS port 2 & 3 of the legacy DMRS ports (i.e., from set A), assuming the same DMRS sequences are re-used for DMRS Rel-18 as was used for DMRS Rel-15/16.

### Antenna Port Indication Table for DMRS Type 1

When scheduling the UE, the gNB indicates in the DCI which antenna ports (i.e., DMRS ports) the UE should use for PDSCH reception. Such indication commonly points to a row in an antenna port indication table. The row selection is made in the gNB scheduler by taking into account, for example, channel estimation performance, whether data is FDM or TDM with the DMRS, and/or whether SU or MU-MIMO scheduling is used.

One important aspect when designing the UL antenna port tables is to ensure that the DMRS ports scheduled simultaneously are, if possible, super-orthogonal to each other when received by the TRP/gNB to minimize the inter-DMRS port interference. Thus, in a particular embodiment, the antenna port indication table contains rows where the DMRS port separated by coding (i.e., OCC) within each CDM group and that are scheduled simultaneously are super-orthogonal (for realistic TRP-UE channel realizations). Table 8 provides some detailed examples of this embodiment for DMRS type 1.

Specifically, in Table 8, some rows of the antenna port table consists of DMRS ports belonging to a single CDM group (for rank 2), where the two DMRS ports are super orthogonal to each other (row “X”, “X+1” & “X+2”). Additionally, some rows of the antenna port table consist of DMRS ports belonging to two different CDM groups, where the two DMRS ports per CDM group are super orthogonal to each other (row “X+3” & “X+4”). It is noted that the DMRS port is computed as 1000 plus Y where Y is the DMRS port index(s) shown in the last column of Table 8. In the rest of the embodiments, DMRS port 1000+Y is referred to as DMRS port Y for simplicity.

TABLE 8
One Codeword:
Codeword 0 enabled;
Codeword 1 disabled

| | Number of DMRS CDM | |
|---|---|---|
| Value | group(s) without data | DMRS port(s) |
| 0 | * | * |
| X | 1 or 2 | 0, 1 |
| X + 1 | 1 or 2 | 2, 3 |
| X + 2 | 2 | 6, 7 |
| X + 3 | 2 | 0, 1, 4, 5 |
| X + 4 | 2 | 2, 3, 6, 7 |
| N-1 | xxx | xxx |
| N-Nmax | Reserved | Reserved |

Antenna port(s) (1000 + DMRS port), dmrs-Type = 1, maxLength = 1, dmrs-Downlink-r18 configured

Another important aspect is to design the Rel-18 DL antenna port tables to enable co-scheduling of Rel-18 UEs using the set B DMRS ports together with legacy UEs using the set A DMRS ports. Thus, in one embodiment the antenna port indication table contains rows where the DMRS port belonging to DMRS port of set B is orthogonal to all (or as many as possible) of the DMRS ports from set A. Table 9 provides some detailed examples of this embodiment for DMRS type 1. As can be seen, for all the rows in Table 9 (i.e., row “X” to “X+5”), the indicated DMRS port are orthogonal to all the legacy DMRS ports (assuming the same DMRS sequences are re-used for DMRS Rel-18 as was used for DMRS Rel-15/16).

TABLE 9
One Codeword:
Codeword 0 enabled;
Codeword 1 disabled

| | Number of DMRS CDM | |
|---|---|---|
| Value | group(s) without data | DMRS port(s) |
| 0 | * | * |
| X | 1 or 2 | 2, 3 |
| X + 1 | 2 | 6, 7 |
| X + 2 | 1 or 2 | 1, 2, 3 |
| X + 3 | 2 | 2, 3, 6 |
| X + 4 | 2 | 0, 1, 4, 5 |
| X + 5 | 2 | 2, 3, 6, 7 |
| N-1 | xxx | xxx |
| N-Nmax | Reserved | Reserved |

Antenna port(s) (dmrs-Type = 1 and single symbol DMRS

In another example embodiment, to enable multiplexing of a legacy UE and a new UE in a same CDM group without affecting existing channel estimation in the legacy UE, the new antenna table may include entries such as those shown in Table 10, where entries X to X+5 enable multiplexing a new UE with rank 1 transmission with a new DMRS port and a legacy UE with a legacy DMRS port in a same CDM group. Entries X+6 to X+11 enables multiplexing a new UE with rank 2 to rank 4 transmission with new DMRS ports in one CDM group and one or two legacy UEs with legacy DMRS ports (or other new UE(s) with new DMRS port(s)) in the other CDM group.

TABLE 10
One Codeword:
Codeword 0 enabled;
Codeword 1 disabled

| | Number of DMRS CDM | |
|---|---|---|
| Value | group(s) without data | DMRS port(s) |
| X | 1 | 0 |
| X + 1 | 1 | 1 |
| X + 2 | 2 | 0 |
| X + 3 | 2 | 1 |
| X + 4 | 2 | 4 |
| X + 5 | 2 | 5 |
| X + 6 | 2 | 0, 1 |
| X + 7 | 2 | 4, 5 |
| X + 8 | 2 | 0, 1, 2 |
| X + 9 | 2 | 4, 5, 6 |
| X + 10 | 2 | 0, 1, 2, 3 |
| X + 11 | 2 | 4, 5, 6, 7 |

Antenna port(s) (dmrs-Type = 1 and single symbol DMRS)

For supporting Non-Coherent Joint Transmission (NC-JT), additional rows are added to allow DMRS ports from different CDM groups to be used for a PDSCH, while the DMRS ports within each CDM group are super-orthogonal to each other. By adding multiple different rows, where the different rows contain different number of DMRS ports per CDM group, NC-JT transmission (at least for the Rel-15/16 Transmission Configuration Indication (TCI) state framework, where the number of each CDM group is associated with one TRP) is enabled with different number of layers (1+1, 1+2, 2+1 and 2+2) from respective TRP. Some detailed examples of this embodiment for DMRS type 1 are illustrated in Table 11. As can be seen in Table 11, row “X” will support 1+1 layers from TRP1 and TRP2 respectively, row “X+1” will support 2+1 layers from TRP1 and TRP2 respectively, and where super-orthogonality is achieved between the two DMRS ports that belongs to CDM group 0 (i.e. DMRS port 0 and 1), row “X+2” will support 1+2 layers from TRP1 and TRP2 respectively, and where super-orthogonality is achieved between the two DMRS ports that belongs to CDM group 1 (i.e., DMRS port 4 and 5), and row “X+3” will support 2+2 layers from TRP1 and TRP2 respectively, and where super-orthogonality is achieved between the two DMRS ports that belongs to CDM group 0 (i.e., DMRS port 0 and 1) and CDM group 1 (i.e., DMRS port 4 and 5).

TABLE 11
One Codeword:
Codeword 0 enabled;
Codeword 1 disabled

| | Number of DMRS CDM | |
|---|---|---|
| Value | group(s) without data | DMRS port(s) |
| 0 | * | * |
| X | 2 | 0, 4 |
| X + 1 | 2 | 0, 1, 4 |
| X + 2 | 2 | 0, 4, 5 |
| X + 3 | 2 | 0, 1, 4, 5 |
| N-1 | xxx | xxx |
| N-Nmax | Reserved | Reserved |

Antenna port(s) (1000 + DMRS port), dmrs-Type = 1, maxLength = 1, dmrs-Downlink-r18 configured

Up to 8 layers can be supported with for DMRS type 1 for single-symbol DMRS with the extended Rel-18 DMRS port framework. Hence, in a particular embodiment, a new antenna port table for two codewords for a single-symbol DMRS is generated, and where the following rows can be added, as illustrated in Table 12. As can be seen in Table 12, row “X” will support 5 layer PDSCH transmission with a single symbol DMRS, row “X+1” will support 5 layer PDSCH transmission with a single symbol DMRS, and where all the DMRS ports are orthogonal to legacy DMRS port 2&3, row “X+2” will support 6 layer PDSCH transmission with a single symbol DMRS, and where all the DMRS ports are orthogonal to legacy DMRS port 2&3, row “X+3” will support 7 layer PDSCH transmission with a single symbol DMRS, and where all the DMRS ports are orthogonal to legacy DMRS port 2, and row “X+4” will support 8 layer PDSCH transmission with a single symbol DMRS.

TABLE 12
One Codeword:
Codeword 0 enabled;
Codeword 1 disabled

| | Number of DMRS CDM | |
|---|---|---|
| Value | group(s) without data | DMRS port(s) |
| 0 | * | * |
| X | 2 | 0, 4 |
| X + 1 | 2 | 0, 1, 2, 3, 6 |
| X + 2 | 2 | 0, 1, 2, 3, 6, 7 |
| X + 3 | 2 | 0, 1, 2, 3, 5, 6, 7 |
| X + 4 | 2 | 0, 1, 2, 3, 4, 5, 6, 7 |
| N-1 | xxx | xxx |
| N-Nmax | Reserved | Reserved |

Antenna port(s) (1000 + DMRS port), dmrs-Type = 1, maxLength = 1, dmrs-Downlink-r18 configured

### Port Numbering for DMRS Type 2

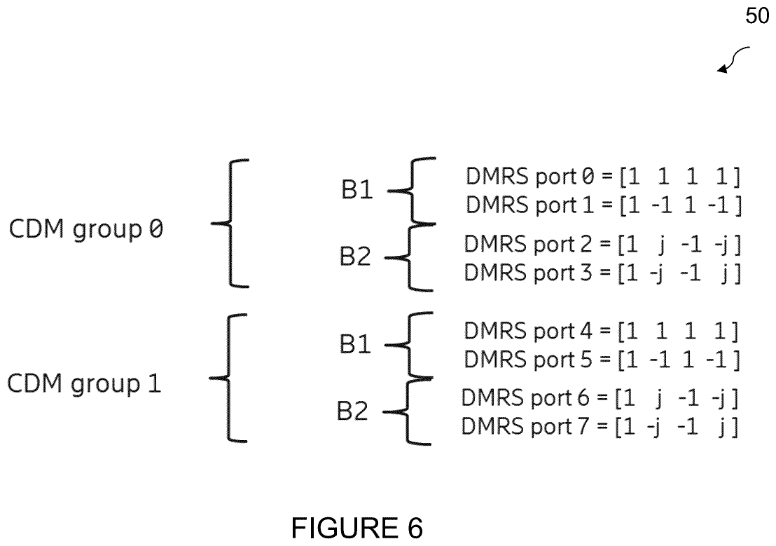

FIG. 7 illustrates an example 75 of DMRS port numbering for DMRS type 2, according to certain embodiments. As shown in FIG. 7, the ports within B1 are mutually super-orthogonal with each other, and the ports within B2 are mutually super-orthogonal with each other. For legacy UEs (set A), it is assumed that the same DMRS port numbering and definitions as described in NR Rel-15 specification. Please note that a FD-OCC code of length 4 has been assumed for the set B DMRS ports; however, that is just one example of how the new DMRS Ports can be implemented by extending the number of orthogonal FD codes per CDM group. By this definition, it can be seen that DMRS port 0 & 1 of set B are the same as the DMRS port 0 & 1 of the legacy DMRS ports (i.e. from set A), DMRS port 4 & 5 of set B are the same as the DMRS port 2 & 3 of the legacy DMRS ports (i.e. from set A) and DMRS port 8 & 9 of set B are the same as the DMRS port 4 & 5 of the legacy DMRS ports (i.e. from set A), assuming the same DMRS sequences are re-used for DMRS Rel-18 as was used for DMRS Rel-15/16.

### Antenna Port Indication Table for DMRS Type 2

As described above for DMRS type 1, in a particular embodiment, the antenna port indication table contains rows where the DMRS port separated by coding (OCC) within each CDM group and that are scheduled simultaneously are super-orthogonal (for realistic TRP-UE channel realizations). Some detailed examples of this embodiment for DMRS Type 2 are illustrated in Table 13. As shown, some rows of the antenna port table consists of DMRS ports belonging to a single CDM group (for rank 2), and where the two DMRS ports are super orthogonal to each other (row “X”, “X+1”, “X+2”, “X+3”). Additionally, some rows of the antenna port table consist of DMRS ports belonging to two different CDM groups, and where the two DMRS ports per CDM group are super orthogonal to each other (row “X+4”, “X+5”, “X+6” and “X+7”).

TABLE 13
One Codeword:
Codeword 0 enabled;
Codeword 1 disabled

| | Number of DMRS CDM | |
|---|---|---|
| Value | group(s) without data | DMRS port(s) |
| 0 | | * |
| X | 1, 2, or 3 | 0, 1 |
| X + 1 | 1, 2, or 3 | 2, 3 |
| X + 2 | 2 or 3 | 6, 7 |
| X + 3 | 3 | 10, 11 |
| X + 4 | 3 | 2, 3, 6, 7 |
| X + 5 | 2 or 3 | 0, 1, 4, 5 |
| X + 6 | 2 or 3 | 2, 3, 6, 7 |
| X + 7 | 3 | 2, 3, 10, 11 |
| N-1 | xxx | xxx |
| N-Nmax | Reserved | Reserved |

Antenna port(s) (dmrs-Type = 2, maxLength = 1 and dmrs-Downlink-r18 configured)

As described above for DMRS type 1, an important aspect is to design the Rel-18 UL antenna port tables to enable co-scheduling of Rel-18 UEs using the set B DMRS ports together with legacy UEs using the set A DMRS ports. Thus, in a particular embodiment, the antenna port indication table contains rows where the DMRS port belonging to DMRS ports of set B is orthogonal to all (or as many as possible) of the DMRS ports from set A (assuming the same DMRS sequences are re-used for DMRS Rel-18 as was used for DMRS Rel-15/16). Some detailed examples of this embodiment for DMRS type 2 are illustrated in Table 14, which shows An example of rows in new antenna port tables for DMRS type 2 and single symbol DMRS, where the DMRS ports belonging to the same row are orthogonal to all the legacy DMRC ports for DMRS type 2.

TABLE 14
One Codeword:
Codeword 0 enabled;
Codeword 1 disabled

| | Number of DMRS CDM | |
|---|---|---|
| Value | group(s) without data | DMRS port(s) |
| 0 | * | * |
| X + 1 | 2or 3 | 2, 3 |
| X + 2 | 2 or 3 | 6, 7 |
| X + 3 | 3 | 10, 11 |
| X + 4 | 3 | 2, 3, 6, 7 |
| X + 5 | 2 or 3 | 2, 3, 6, 7 |
| X + 6 | 3 | 2, 3, 10, 11 |
| N-1 | xxx | xxx |
| N-Nmax | Reserved | Reserved |

Antenna port(s) (dmrs-Type = 2, maxLength = 1 and dmrs-Downlink-r18 configured)

In another particular embodiment, to enable multiplexing of a legacy UE and a new UE in a same CDM group without affecting existing channel estimation in the legacy UE, the new antenna table may include entries such as those shown in Table 15, where entries X+2 to X+11 enable multiplexing a new UE with rank 1 transmission with a new DMRS port 0, 1, 4, 5, 8, or 9, and a legacy UE with a legacy DMRS port 1, 0, 3, 2, 5, 4, respectively, in a same CDM group.

TABLE 15
One Codeword:
Codeword 0 enabled;
Codeword 1 disabled

| | Number of DMRS CDM | |
|---|---|---|
| Value | group(s) without data | DMRS port(s) |
| X | 1 | 0 |
| X + 1 | 1 | 1 |
| X + 2 | 2 | 0 |
| X + 3 | 2 | 1 |
| X + 4 | 2 | 4 |
| X + 5 | 2 | 5 |
| X + 6 | 3 | 0 |
| X + 7 | 3 | 1 |
| X + 8 | 3 | 4 |
| X + 9 | 3 | 5 |
| X + 10 | 3 | 8 |
| X + 11 | 3 | 9 |

Antenna port(s) (dmrs-Type = 2, maxLength = 1 and dmrs-Downlink-r18configured)

According to certain embodiments, a method of indicating DMRS antenna ports for PDSCH reception includes:
allocating 4 DMRS ports per CDM group per resource block, where the DMRS ports per CDM group per resource block are differentiated by different FD codes (e.g., FD-OCC)·
receiving an indication of a codepoint of an antenna port field in a DCI for scheduling PDSCH indicating at least one of the following
   1 spatial layer via DMRS ports x1 wherein DMRS port x1 corresponds to CDM group index y1
   2 spatial layers via DMRS ports x1 and x2 wherein DMRS port x1 corresponds to CDM group index y1 and DMRS port x2 corresponds to CDM group index y2
   3 spatial layers via DMRS ports x3, x4, and x5 respectively corresponding to CDM group indices y3, y4, and y5
   4 spatial layers via DMRS ports x6, x7, x8, and x9 respectively corresponding to CDM group indices y6, y7, y8 and y9
   5 spatial layers via DMRS ports x10, x11, x12, x13 and x14 respectively corresponding to CDM group indices y10, y11, y12, y13 and y14
   6 spatial layers via DMRS ports x15, x16, x17, x18, x19 and x20 respectively corresponding to CDM group indices y15, y16, y17, y18, y19 and y20
   7 spatial layers via DMRS ports x21, x22, x23, x24, x25, x26 and x27 respectively corresponding to CDM group indices y21, y22, y23, y24, y25, y26 and y27
   8 spatial layers via DMRS ports x28, x29, x30, x31, x32, x33, x34 and x35 respectively corresponding to CDM group indices y28, y29, y30, y31, y32, y33, y34 and y35
receiving PDSCH according to the DMRS ports in the indicated received in the codepoint of the antenna port field.

In a particular embodiment, for 1 spatial layer, x1 of CDM group index y1 is selected such that it is super-orthogonal to one out of two DMRS port of CDM group y1 when two FD-OCC codes are used per CDM group.

As just one example, in a particular embodiment, x1=1000 (i.e. DMRS port 0 as defined herein), y1=0 (i.e. CDM group 0 as defined herein). Similar embodiments may be defined for X+1, X+2, X+3, X+5, etc. for the various tables described above.

As another example, in a particular embodiment, y1 is equal to y2, and x1 and x2 are mutual super-orthogonal. This is given as just one example, and it is recognized that similar methods may be used to reach super orthogonality between DMRS ports of the same CDM group for the different and various ranks and types of DRMS.

As another example, in a particular embodiment, x1=1000 (i.e., DMRS port 0 as defined herein), x2=1001 (i.e., DMRS port 1 as defined herein), y1=0 (i.e., CDM group 0 as defined herein), and y2-0 (i.e., CDM group 0 as defined herein). Again, this is given as just one example, and it is recognized that similar methods may be used to reach super orthogonality between DMRS ports of the same CDM group for the different and various ranks and types of DRMS.

As still another example, in a particular embodiment for 3 spatial layers, y1 and y2 are equal to y3, and x1, x2 and x3 are orthogonal to one out of two DMRS port of a CDM group that includes y1, y2, and y3 when two FD-OCC codes are used per CDM group. Thus, in this way, DMRS ports in the same row are orthogonal to legacy DMRS ports. Again, this is given as just one example, and it is recognized that similar methods may be used to reach super orthogonality between DMRS ports of the same CDM group for the different and various ranks and types of DRMS.

As another example, in a particular embodiment, for 3 spatial layers, y1 and y2 are equal to y3, and x1, x2 and x3 are orthogonal to one out of two DMRS port of a CDM group that includes y1, y2, and y3 when two FD-OCC codes are used per CDM group. Again, this is given as just one example, and it is recognized that similar methods may be used to reach super orthogonality between DMRS ports of the same CDM group for the different and various ranks and types of DRMS.

As still another example, in a particular embodiment, for 4 spatial layers, y6 is equal to y7, y8 is equal to y9, y6, and y7 are different from y8 and y9, x6, and x7 are mutual super-orthogonal, and x8 and x9 are mutually super-orthogonal. Again, this is given as just one example, and it is recognized that similar methods may be used to reach super orthogonality between DMRS ports of the same CDM group for the different and various ranks and types of DRMS.

In a particular embodiment, a flag is introduced in RRC, and when the RRC flag is configured, the UE will assume the new set of DMRS ports and the associated antenna port tables.

Conversely, in a particular embodiment, when the flag is absent or not configured the UE should assume the legacy DMRS port and the associated antenna port tables.

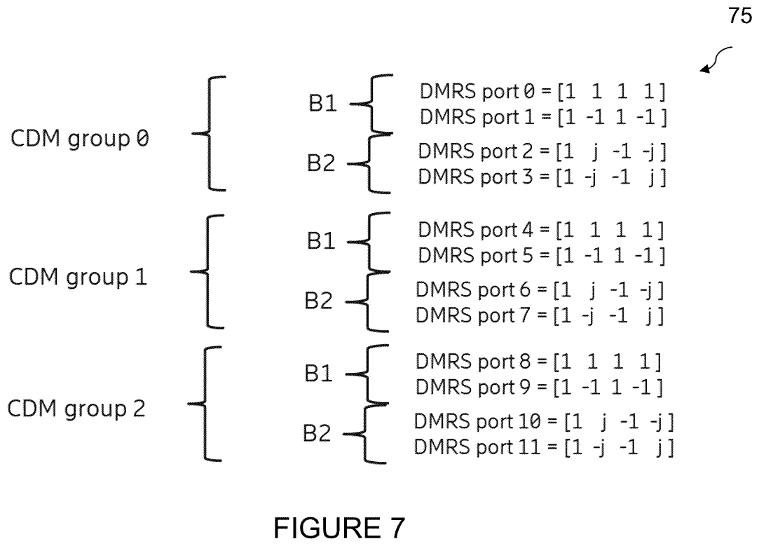

FIG. 8 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

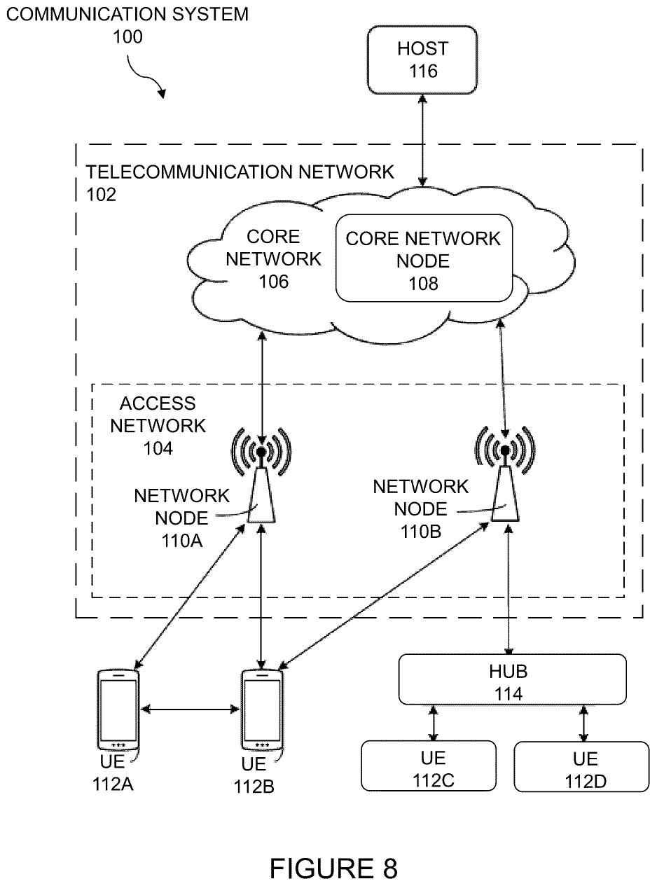

FIG. 9 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (N_{B}-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP N_{B}-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

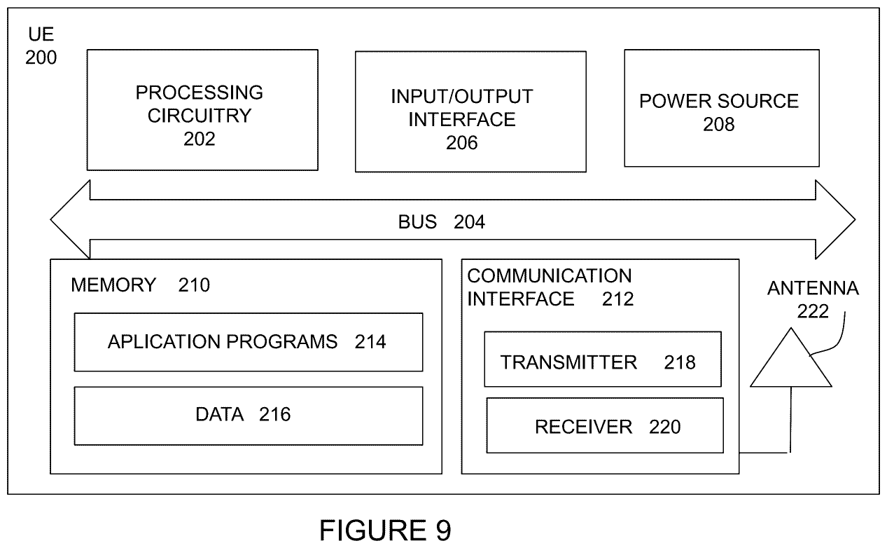

FIG. 10 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 10 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

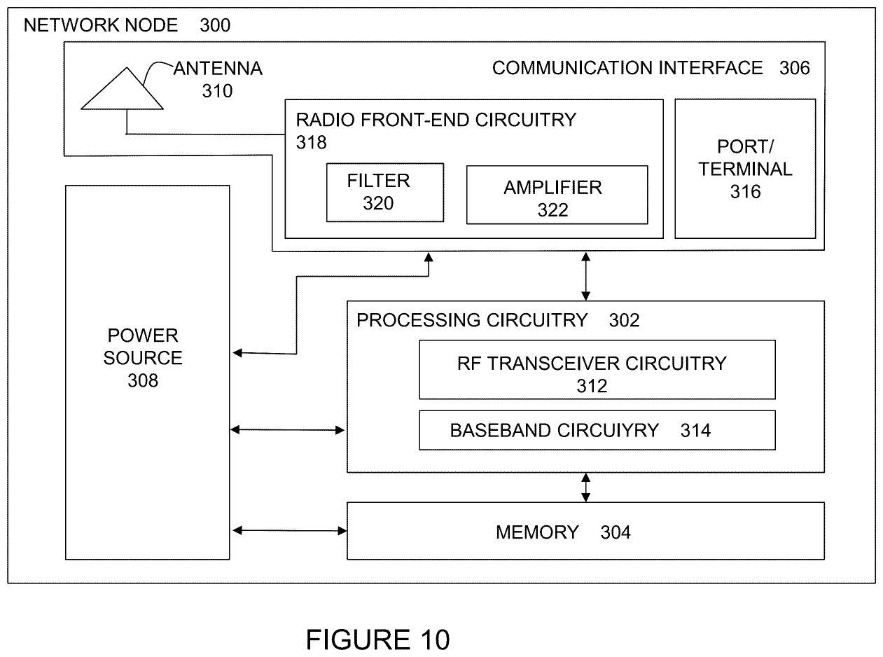

FIG. 11 is a block diagram of a host 400, which may be an embodiment of the host 116 of FIG. 8, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

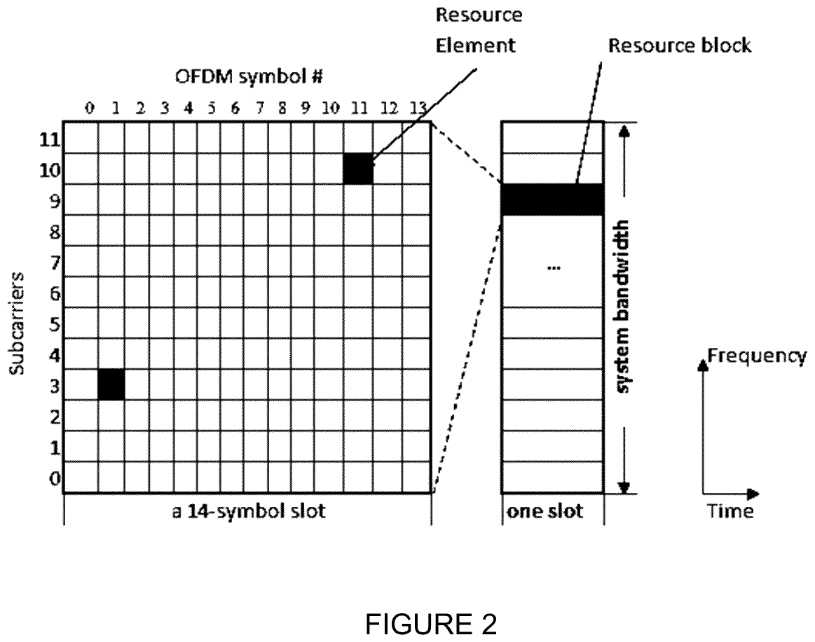

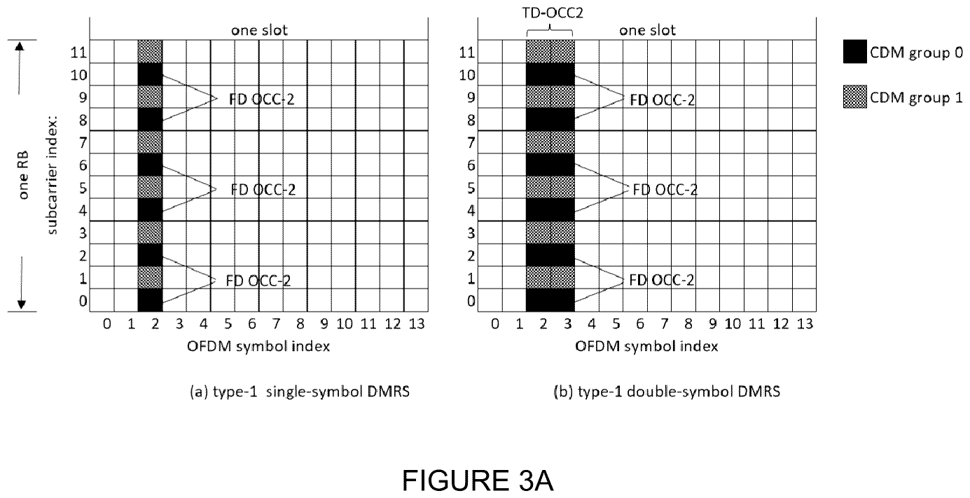

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

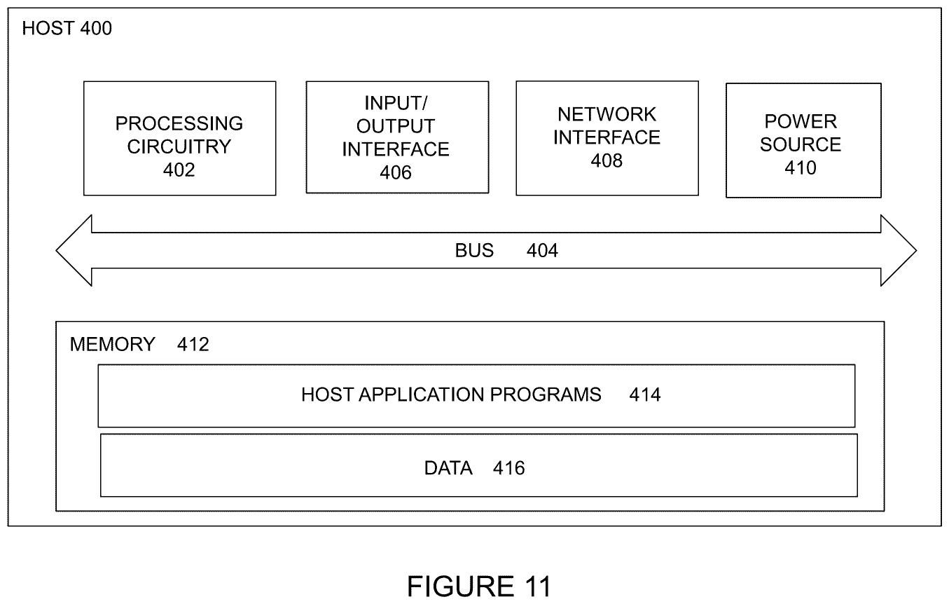

FIG. 12 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

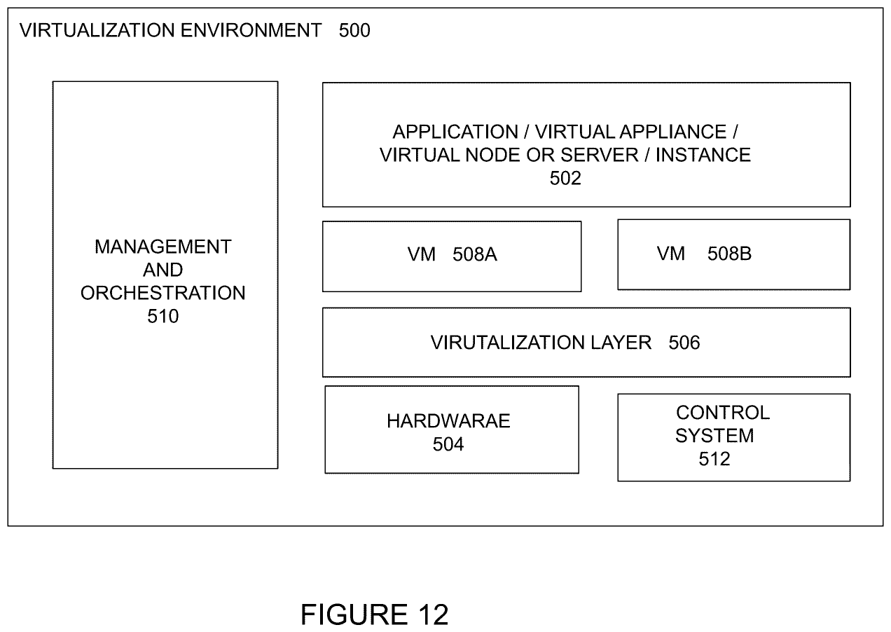

FIG. 13 shows a communication diagram of a host 602 communicating via a network node 604 with a UE 606 over a partially wireless connection in accordance with some embodiments.

Example implementations, in accordance with various embodiments, of the UE (such as a UE 112a of FIG. 8 and/or UE 200 of FIG. 9), network node (such as network node 110a of FIG. 8 and/or network node 300 of FIG. 10), and host (such as host 116 of FIG. 8 and/or host 400 of FIG. 11) discussed in the preceding paragraphs will now be described with reference to FIG. 13.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 8) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

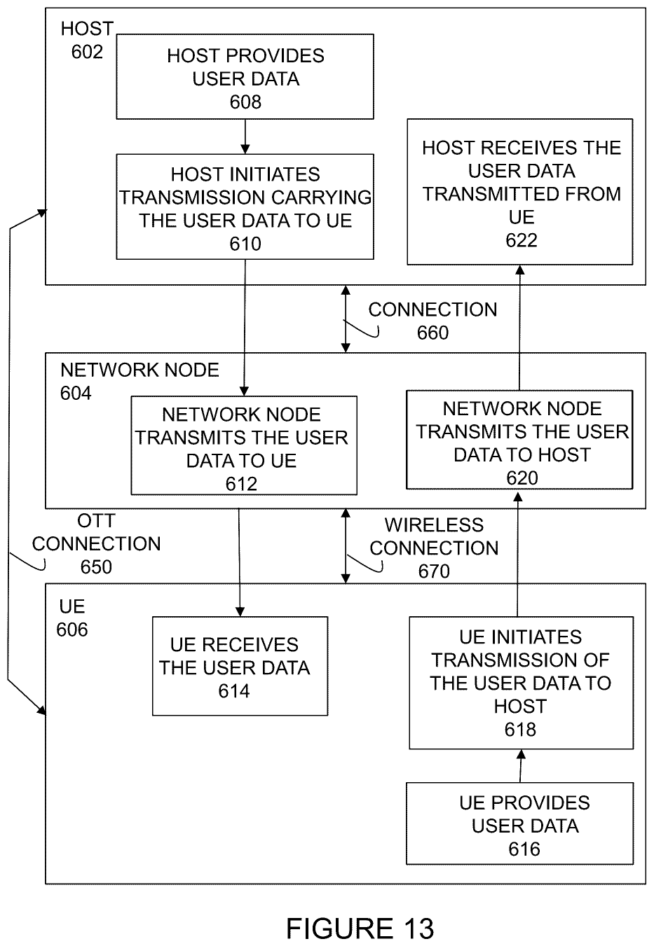

FIG. 14 illustrates a method 700 by a UE 112 for receiving a PDSCH transmission, according to certain embodiments. The method begins at step 702 when the UE 112 receives, from a network node 110, in a DCI information about two or more DMRS ports in a CDM group associated to the PDSCH transmission. The two or more DMRS ports are orthogonal at a length n, and the two or more DMRS ports are orthogonal over a partial length n′ that is less than n. At step 704, the UE 112 receives, from the network node 110, the PDSCH transmission with the two or more DMRS ports in the CDM group.

In a particular embodiment, n=4 and n′=2.

In a particular embodiment, the UE 112 receives a RRC message comprising an indicator to use a DMRS port with a length n=4. Based on the indicator, the UE 112 determines to use the two or more DMRS ports in the CDM group for receiving the PDSCH transmission.

In a particular embodiment, the indicator is in a DMRS-DownlinkConfig information element.

In a particular embodiment, the RRC message comprises a configuration of an allocation of four or more DMRS ports per CDM group, and the four or more DMRS ports per CDM group are differentiated by different FD codes.

In a particular embodiment, the DCI comprises information indicating a number of allocated CDM groups without data.

In a particular embodiment, a first FD first length n code

$${v}_{1} = [ \begin{matrix}{v}_{1 , 1} \\ … \\ {v}_{1 , K}\end{matrix} ]$$

and a second length n FD code

$${v}_{2} = [ \begin{matrix}{v}_{2 , 1} \\ … \\ {v}_{2 , K}\end{matrix} ]$$

are orthogonal and each pair of associated length n′ codes, v_{1,i} and v_{2,i}, are also orthogonal for i=1, 2, . . . , K, wherein 1<n′<n and n=n′*K.

In a particular embodiment, the two or more DMRS ports in the CDM group are differentiated by different FD codes.

In a particular embodiment, the FD codes comprise FD-OCCs.

In a particular embodiment, the PDSCH transmission comprises 2 spatial layers received via DMRS ports x1 and x2. DMRS port x1 corresponds to a CDM group index y1, and DMRS port x2 corresponds to a CDM group index y2. The CDM group index y1 and the CDM group index y2 are equal.

In a particular embodiment, the PDSCH transmission comprises 4 spatial layers received via DMRS ports x6, x7, x8, and x9, respectively. DMRS ports x6, x7, x8, and x9 correspond to CDM group indices y6, y7, y8 and y9, respectively. DMRS port x6 and DMRS port x7 are orthogonal at a length n and partial length n′. DMRS port x8 and DMRS port x9 are orthogonal at a length n and partial length n′. The CDM group index y6 is equal to the CDM group index y7, and the CDM group index y8 is equal to the CDM group index y9. CDM group index y6 and CDM group y7 are not equal to CDM group index y8 and CDM group index y9.

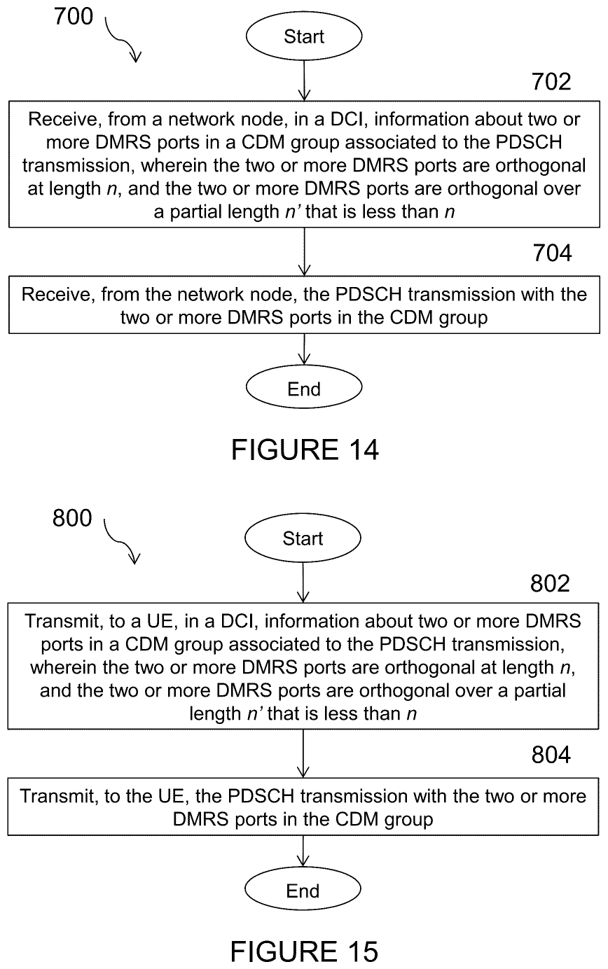

FIG. 15 illustrates a method 800 by a network node 110 for transmitting a PDSCH transmission, according to certain embodiments. The method begins at step 802 when the network node 110 transmits, to a UE, in a DCI, information about two or more DMRS ports in a CDM group associated to the PDSCH transmission. The two or more DMRS ports are orthogonal at a length n, and the two or more DMRS ports are orthogonal over a partial length n′ that is less than n. At step 804, the network node 110 transmits, to the UE, the PDSCH transmission with the two DMRS ports in the CDM group.

In a particular embodiment, n=4 and n′=2.

In a particular embodiment, the network node 110 transmits a RRC message comprising an indicator for the UE to use a DMRS port with a length n=4 for receiving the PDSCH transmission.

In a particular embodiment, the indicator is in a DMRS-DownlinkConfig information element.

In a particular embodiment, the RRC message comprises a configuration of an allocation of four or more DMRS ports per CDM group, and the four or more DMRS ports per CDM group are differentiated by different FD codes.

In a particular embodiment, the DCI comprises information indicating a number of allocated CDM groups without data.

In a particular embodiment, a first FD first length n code

$${v}_{1} = [ \begin{matrix}{v}_{1 , 1} \\ … \\ {v}_{1 , K}\end{matrix} ]$$

and a second length n FD code

$${v}_{2} = [ \begin{matrix}{v}_{2 , 1} \\ … \\ {v}_{2 , K}\end{matrix} ]$$

are orthogonal and each pair of associated length n′ codes, v_{1,i} and v_{2,i}, are also orthogonal for i=1, 2, . . . , K, wherein 1<n′<n and n=n′*K.

In a particular embodiment, the two or more DMRS ports in the CDM group are differentiated by different FD codes.

In a particular embodiment, the FD codes comprise FD-OCCs.

In a particular embodiment, the PDSCH transmission comprises 2 spatial layers transmitted via DMRS ports x1 and x2. DMRS port x1 corresponds to a CDM group index y1, and DMRS port x2 corresponds to a CDM group index y2. The CDM group index y1 and the CDM group index y2 are equal.

In a particular embodiment, the PDSCH transmission comprises 4 spatial layers received via DMRS ports x6, x7, x8, and x9, respectively. DMRS ports x6, x7, x8, and x9 corresponds to CDM group indices y6, y7, y8 and y9, respectively. DMRS port x6 and DMRS port x7 are orthogonal at a length n and partial length n′, and DMRS port x8 and DMRS port x9 are orthogonal at a length n and partial length n′. The CDM group index y6 is equal to the CDM group index y7, and the CDM group index y8 is equal to the CDM group index y9. CDM group index y6 and CDM group y7 are not equal to CDM group index y8 and CDM group index y9.

### EXAMPLE EMBODIMENTS

### Group A Example Embodiments

Example Embodiment A1. A method by a user equipment (UE) for receiving a physical downlink shared channel (PDSCH) transmission, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for providing information for a physical downlink shared channel (PDSCH) transmission, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for receiving a physical downlink shared channel (PDSCH) transmission, the method comprising: obtaining an allocation of a number of Demodulation Reference Signal (DMRS) ports per Code Division Multiplexing (CDM) group per resource block, where the DMRS ports per CDM group per resource block are differentiated by different FD codes; receiving an indication of a codepoint of an antenna port field in a Downlink Control Information (DCI) for scheduling the PDSCH transmission; based on the indication of the codepoint of the antenna port field and the allocation of the number of DMRS ports per CDM group per resource block, determine at least one DMRS port for the PDSCH transmission, wherein each DMRS port corresponds to one FDD code of length, n, and one CDM group, and wherein if there are two or more DMRS ports, the two or more DMRS ports are orthogonal at length n, and wherein corresponding subsets within each FDD code with length n′ that is less than n are orthogonal at length n′; and receiving the PDSCH transmission according to the determined at least one DMRS port.

Example Embodiment C2. The method of Example Embodiment C1, wherein the number of ports corresponds to a number of layers.

Example Embodiment C3. The method of any one of Example Embodiments C1 to C2, wherein n=4 and n′=2.

Example Embodiment C4. The method of any one of Example Embodiments C1 to C3, wherein obtaining the allocation comprises determining the number of DMRS ports per CDM group per resource block based on a preconfigured specification.

Example Embodiment C5. The method of any one of Example Embodiments C1 to C4, wherein obtaining the allocation comprises determining the number of DMRS ports per CDM group per resource block based on at least one lookup table.

Example Embodiment C6. The method of any one of Example Embodiments C1 to C5, wherein obtaining the allocation comprises receiving the allocation indicating the number of DMRS ports per CDM group per resource block from a network node.

Example Embodiment C7. The method of any one of Example Embodiments C1 to C6, wherein at least one of:
1 spatial layer via DMRS ports x1 wherein DMRS port x1 corresponds to CDM group index y1;
2 spatial layers via DMRS ports x1 and x2 wherein DMRS port x1 corresponds to CDM group index y1 and DMRS port x2 corresponds to CDM group index y2;
3 spatial layers via DMRS ports x3, x4, and x5 respectively corresponding to CDM group indices y3, y4, and y5;
4 spatial layers via DMRS ports x6, x7, x8, and x9 respectively corresponding to CDM group indices y6, y7, y8 and y9;
5 spatial layers via DMRS ports x10, x11, x12, x13 and x14 respectively corresponding to CDM group indices y10, y11, y12, y13 and y14;
6 spatial layers via DMRS ports x15, x16, x17, x18, x19 and x20 respectively corresponding to CDM group indices y15, y16, y17, y18, y19 and y20;
7 spatial layers via DMRS ports x21, x22, x23, x24, x25, x26 and x27 respectively corresponding to CDM group indices y21, y22, y23, y24, y25, y26 and y27; and
8 spatial layers via DMRS ports x28, x29, x30, x31, x32, x33, x34 and x35 respectively corresponding to CDM group indices y28, y29, y30, y31, y32, y33, y34 and y35.

Example Embodiment C8. The method of any one of Example Embodiments C1 for C7, wherein each port number, x1, is determined from an antenna port table, and a corresponding y1 is determined based on the allocation of x1 to a CDM group number, y1, and the FDD code.

Example Emboidment C9. The method of any one of Example Embodiments C1 to C8, further comprising: receiving a Radio Resource Control (RRC) message comprising a flag or indicator; and determining, based on the flag or indicator, to use the allocation for the PDSCH reception.

Example Emboidment C10. The method of any one of Example Embodiments C1 to C8, further comprising: receiving a Radio Resource Control (RRC) message that does not include a flag or indicator; and determining, based on the RRC not including the flag or indicator, not to use the allocation for at least one additional PDSCH reception.

Example Emboidment C11. The method of any one of Example Embodiments C1 to C10, wherein the FDD codes comprise Frequency Division-Orthogonal Cover Codes (FD-OCC).

Example Embodiment C12. The method of Example Embodiments C1 to C11, further comprising: providing user data; and forwarding the user data to a host via the transmission to the network node.

Example Embodiment C13. A user equipment comprising processing circuitry configured to perform any of the methods of Example Embodiments C1 to C12.

Example Embodiment C14. A wireless device comprising processing circuitry configured to perform any of the methods of Example Embodiments C1 to C12.

Example Embodiment C15. A computer program comprising instructions which when executed on a computer perform any of the methods of Example Embodiments C1 to C12.

Example Embodiment C16. A computer program product comprising computer program, the computer program comprising instructions which when executed on a computer perform any of the methods of Example Embodiments C1 to C12.

Example Embodiment C17. A non-transitory computer readable medium storing instructions which when executed by a computer perform any of the methods of Example Embodiments C1 to C12.

### Group D Example Embodiments

Example Embodiment D1. A method by a network node for providing information for a physical downlink shared channel (PDSCH) transmission, the method comprising: obtaining an allocation of a number of DMRS ports per CDM group per resource block, where the DMRS ports per CDM group per resource block are differentiated by different FD codes; transmitting, to a user equipment (UE), an indication of a codepoint of an antenna port field in a DCI for scheduling the PDSCH transmission; based on the indication of the codepoint of the antenna port field and the allocation of the number of DMRS ports per CDM group per resource block, determine at least one DMRS port for the PDSCH transmission, wherein each DMRS port corresponds to one FDD code of length, n, and one CDM group, and wherein if there are two or more DMRS ports, the two or more DMRS ports are orthogonal at length n, and wherein corresponding subsets within each FDD code with length n′ that is less than n are orthogonal at length n′; and transmitting, to the UE, the PDSCH transmission according to the determined at least one DMRS port.

Example Embodiment D2. The method of Example Embodiment D1, wherein the number of ports corresponds to a number of layers.

Example Embodiment D3. The method of any one of Example Embodiments D1 to D2, wherein n=4 and n′=2.

Example Embodiment D4. The method of any one of Example Embodiments D1 to D3, wherein obtaining the allocation comprises determining the number of DMRS ports per CDM group per resource block based on a preconfigured specification.

Example Embodiment D5. The method of any one of Example Embodiments D1 to D4, wherein obtaining the allocation comprises determining the number of DMRS ports per CDM group per resource block based on at least one lookup table.

Example Embodiment D6. The method of any one of Example Embodiments D1 to D5, further comprising transmitting, to the UE, the allocation indicating the number of DMRS ports per CDM group per resource block.

Example Embodiment D7. The method of any one of Example Embodiments D1 to D6, wherein at least one of:
1 spatial layer via DMRS ports x1 wherein DMRS port x1 corresponds to CDM group index y1;
2 spatial layers via DMRS ports x1 and x2 wherein DMRS port x1 corresponds to CDM group index y1 and DMRS port x2 corresponds to CDM group index y2;
3 spatial layers via DMRS ports x3, x4, and x5 respectively corresponding to CDM group indices y3, y4, and y5;
4 spatial layers via DMRS ports x6, x7, x8, and x9 respectively corresponding to CDM group indices y6, y7, y8 and y9;
5 spatial layers via DMRS ports x10, x11, x12, x13 and x14 respectively corresponding to CDM group indices y10, y11, y12, y13 and y14;
6 spatial layers via DMRS ports x15, x16, x17, x18, x19 and x20 respectively corresponding to CDM group indices y15, y16, y17, y18, y19 and y20;
7 spatial layers via DMRS ports x21, x22, x23, x24, x25, x26 and x27 respectively corresponding to CDM group indices y21, y22, y23, y24, y25, y26 and y27; and
8 spatial layers via DMRS ports x28, x29, x30, x31, x32, x33, x34 and x35 respectively corresponding to CDM group indices y28, y29, y30, y31, y32, y33, y34 and y35.

Example Embodiment D8. The method of any one of Example Embodiments D1 for D7, wherein each port number, x1, is determined from an antenna port table, and a corresponding y1 is determined based on the allocation of x1 to a CDM group number, y1, and the FDD code.

Example Embodiment D9. The method of any one of Example Embodiments D1 to D8, further comprising: transmitting, to the UE, a Radio Resource Control (RRC) message comprising a flag or indicator, the flag or indicator indicating that the UE is to use the allocation for receiving the PDSCH transmission.

Example Embodiment D10. The method of any one of Example Embodiments D1 to D8, further comprising: transmitting, to the UE, a Radio Resource Control (RRC) message that does not include a flag or indicator, the flag or indicator indicating that the UE is not to use the allocation for receiving at least one additional PDSCH transmission.

Example Embodiment D11. The method of any one of Example Embodiments D1 to D10, wherein the FDD codes comprise Frequency Division-Orthogonal Cover Codes (FD-OCC).

Example Embodiment D12. The method of any one of Example Embodiments D1 to D11, wherein the network node comprises a gNodeB (gNB).

Example Embodiment D13. The method of any of the previous Example Embodiments, further comprising: obtaining user data; and forwarding the user data to a host or a user equipment.

Example Embodiment D14. A network node comprising processing circuitry configured to perform any of the methods of Example Embodiments D1 to D13.

Example Embodiment D15. A computer program comprising instructions which when executed on a computer perform any of the methods of Example Embodiments D1 to D13.

Example Embodiment D16. A computer program product comprising computer program, the computer program comprising instructions which when executed on a computer perform any of the methods of Example Embodiments D1 to D13.

Example Embodiment D17. A non-transitory computer readable medium storing instructions which when executed by a computer perform any of the methods of Example Embodiments D1 to D13.

### Group E Example Embodiments

Example Embodiment E1. A user equipment comprising: processing circuitry configured to perform any of the steps of any of the Group A and C Example Embodiments; and power supply circuitry configured to supply power to the processing circuitry.

Example Embodiment E2. A network node comprising: processing circuitry configured to perform any of the steps of any of the Group B and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Emboidment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Emboidment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for receiving a physical downlink shared channel, PDSCH, transmission, the method comprising:
receiving, from a network node, in a Downlink Control Information, DCI, information about two or more Demodulation Reference Signal, DMRS, ports in a Code Division Multiplexing, CDM, group associated to the PDSCH transmission, wherein:
the two or more DMRS ports are orthogonal at a length n, and
the two or more DMRS ports are orthogonal over a partial length n′ that is less than n, and
receiving, from the network node, the PDSCH transmission with the two or more DMRS ports in the CDM group.

2. The method of claim 1, wherein n=4 and n′=2.

3. The method of claim 1, comprising:
receiving a Radio Resource Control, RRC, message comprising an indicator to use a DMRS port with a length n=4; and
based on the indicator, determining to use the two or more DMRS ports in the CDM group for receiving the PDSCH transmission.

4. The method of claim 3, wherein the indicator is in a DMRS-DownlinkConfig information element.

5. The method of claim 3, wherein the RRC message comprises a configuration of an allocation of four or more DMRS ports per CDM group, wherein the four or more DMRS ports per CDM group are differentiated by different frequency domain, FD, codes.

6. The method of claim 1, wherein the DCI comprises information indicating a number of allocated CDM groups without data.

7. The method of claim 1, wherein a first FD first length n code
$${v}_{1} = [ \begin{matrix}{v}_{1 , 1} \\ … \\ {v}_{1 , K}\end{matrix} ]$$
and a second length n FD code
$${v}_{2} = [ \begin{matrix}{v}_{2 , 1} \\ … \\ {v}_{2 , K}\end{matrix} ]$$
are orthogonal and each pair of associated length n′ codes, v_{1,i} and v_{2,i}, are also orthogonal for i=1, 2, . . . , K, wherein 1<n′<n and n=n′*K.

8. The method of claim 1, wherein the two or more DMRS ports in the CDM group are differentiated by different frequency domain, FD, codes.

9. The method of claim 8, wherein the FD codes comprise Frequency Division-Orthogonal Cover Codes, FD-OCCs.

10.-11. (canceled)

12. A method by a network node for transmitting a physical downlink shared channel, PDSCH, transmission, the method comprising:
transmitting, to a User Equipment, UE, in a Downlink Control Information, DCI, information about two or more Demodulation Reference Signal, DMRS, ports in a Code Division Multiplexing, CDM, group associated to the PDSCH transmission, wherein:
the two or more DMRS ports are orthogonal at a length n, and
the two or more DMRS ports are orthogonal over a partial length n′ that is less than n, and
transmitting, to the UE, the PDSCH transmission with the two DMRS ports in the CDM group.

13. The method of claim 12, wherein n=4 and n′=2.

14. The method of claim 12, comprising:
transmitting a Radio Resource Control, RRC, message comprising an indicator for the UE to use a DMRS port with a length n=4 for receiving the PDSCH transmission.

15. The method of claim 14, wherein the indicator is in a DMRS-DownlinkConfig information element.

16. The method of claim 14, wherein the RRC message comprises a configuration of an allocation of four or more DMRS ports per CDM group, wherein the four or more DMRS ports per CDM group are differentiated by different frequency domain, FD, codes.

17. The method of claim 12, wherein the DCI comprises information indicating a number of allocated CDM groups without data.

18. The method of claim 12, wherein a first FD first length n code
$${v}_{1} = [ \begin{matrix}{v}_{1 , 1} \\ … \\ {v}_{1 , K}\end{matrix} ]$$
and a second length n FD code
$${v}_{2} = [ \begin{matrix}{v}_{2 , 1} \\ … \\ {v}_{2 , K}\end{matrix} ]$$
are orthogonal and each pair of associated length n′ codes, v_{1,i} and v_{2,i}, are also orthogonal for i=1, 2, . . . , K, wherein 1<n′<n and n=n′*K.

19. The method of claim 12, wherein the two or more DMRS ports in the CDM group are differentiated by different frequency domain, FD, codes.

20. The method of claim 19, wherein the FD codes comprise Frequency Division-Orthogonal Cover Codes, FD-OCCs.

21.-22. (canceled)

23. A user equipment, UE, for receiving a physical downlink shared channel, PDSCH, transmission, the UE adapted to:
receive, from a network node, in a Downlink Control Information, DCI, information about two or more Demodulation Reference Signal, DMRS, ports in a Code Division Multiplexing, CDM, group associated to the PDSCH transmission, wherein:
the two or more DMRS ports are orthogonal at a length n, and
the two or more DMRS ports are orthogonal over a partial length n′ that is less than n, and
receive, from the network node, the PDSCH transmission with the two or more DMRS ports in the CDM group.

24.-33. (canceled)

34. A network node for transmitting a physical downlink shared channel, PDSCH, transmission, the network node adapted to:
transmit, to a User Equipment, UE, in a Downlink Control Information, DCI, information about two or more Demodulation Reference Signal, DMRS, ports in a Code Division Multiplexing, CDM, group associated to the PDSCH transmission, wherein:
the two or more DMRS ports are orthogonal at a length n, and
the two or more DMRS ports are orthogonal over a partial length n′ that is less than n, and
transmit, to the UE, the PDSCH transmission with the two DMRS ports in the CDM group.

35.-44. (canceled)
